(19) United States
(12) Patent Application Publication
(10) Pub. No.: US 2026/0163677 A1
(43) Pub. Date: Jun. 11, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP)

(73) Assignee: NTT DOCOMO, INC., Tokyo (JP)

(21) Appl. No.: 18/707,073

(22) PCT Filed: Nov. 5, 2021
(86) PCT No.: PCT/JP2021/040878

§ 371 Date: May 2, 2024

(51) Int. Cl. H04L 1/1812; H04W 72/1273; H04W 72/232

(52) U.S. Cl. CPC H04L 1/1812; H04W 72/1273; H04W 72/232

(57) ABSTRACT

A terminal according to one aspect of the present disclosure includes a receiving section that receives a plurality of downlink control information (DCI) formats, and a control section that applies one or more transmission configuration indication (TCI) states based on one or more DCI formats among the plurality of DCI formats at a specific timing after the plurality of DCI formats.

One of the plurality of DCI formats, a plurality of physical downlink shared channels scheduled by the plurality of DCI formats, a plurality of Hybrid Automatic Repeat reQuest ACKnowledgement (HARQ-ACK) information bits corresponding to the plurality of DCI formats, and an ACK corresponding to the plurality of DCI formats is indexed. The control section determines the one or more DCI formats, based on order of the index. According to one aspect of the present disclosure, the TCI state can be appropriately determined.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1:3GPP TS 36.300 V 8.12.0 “Evolved Universal Terrestrial Radio Access (E-UTRA) and Evolved Universal Terrestrial Radio Access Network (E-UTRAN) ; Overall description; Stage 2 (Release 8),” April, 2010

### SUMMARY OF INVENTION

### Technical Problem

In future radio communication systems, it has been studied that a transmission configuration indication (TCI) state for one or more channels/signals is indicated by single downlink control information.

However, when a UE receives a plurality of DCIs related to the TCI state, how to determine the TCI state is unclear. Unless an operation for the plurality of DCIs is clear, communication throughput may be reduced.

In view of this, the present disclosure has one object to provide a terminal, a radio communication method, and a base station that appropriately determine a TCI state.

### Solution to Problem

A terminal according to one aspect of the present disclosure includes a receiving section that receives a plurality of downlink control information (DCI) formats, and a control section that applies one or more transmission configuration indication (TCI) states based on one or more DCI formats among the plurality of DCI formats at a specific timing after the plurality of DCI formats, wherein one of the plurality of DCI formats, a plurality of physical downlink shared channels scheduled by the plurality of DCI formats, a plurality of Hybrid Automatic Repeat reQuest ACKnowledgement (HARQ-ACK) information bits corresponding to the plurality of DCI formats, and an ACK corresponding to the plurality of DCI formats is indexed, and the control section determines the one or more DCI formats, based on order of the index.

### Advantageous Effects of Invention

According to one aspect of the present disclosure, the TCI state can be appropriately determined.

### BRIEF DESCRIPTION OF DRAWINGS

FIG. 1 FIGS. 1A and 1B show examples of unified TCI states.

FIG. 2 shows an example of BAT.

FIG. 3 shows an example of Aspect 1-1.

FIG. 4 shows an example Aspect 1-2.

FIG. 5 shows an example of Aspect 1-4.

FIG. 6 shows an example of a semi-static HARQ-ACK codebook in Aspect 2-1-1.

FIG. 7 shows an example of a dynamic HARQ-ACK codebook in Aspect 2-1-1.

FIG. 8 shows another example of a dynamic HARQ-ACK codebook in Aspect 2-1-1.

FIG. 9 shows an example of a semi-static HARQ-ACK codebook in Aspect 2-1-2.

FIG. 10 shows an example of a dynamic HARQ-ACK codebook in Aspect 2-1-2.

FIG. 11 shows another example of a dynamic HARQ-ACK codebook in Aspect 2-1-2.

FIG. 12 shows an example of indication of joint TCI states.

FIG. 13 shows another example of indication of joint TCI states.

FIG. 14 is a diagram to show an example of a schematic structure of a radio communication system according to one embodiment.

FIG. 15 is a diagram to show an example of a structure of a base station according to one embodiment.

FIG. 16 is a diagram to show an example of a structure of a user terminal according to one embodiment.

FIG. 17 is a diagram to show an example of a hardware structure of the base station and the user terminal according to one embodiment.

FIG. 18 is a diagram to show an example of a vehicle according to one embodiment.

### DESCRIPTION OF EMBODIMENTS

### TCI, Spatial Relation, QCL

For NR, control of reception processing (for example, at least one of reception, demapping, demodulation, and decoding) and transmission processing (for example, at least one of transmission, mapping, precoding, modulation, and coding) of at least one of a signal and a channel (expressed as a signal/channel) in a UE, based on a transmission configuration indication state (TCI state) is under study.

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like.

The TCI state may be configured for the UE for each channel or for each signal.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), and a reference signal for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X in a TCI state may mean an RS in a relationship of QCL type X with (a DMRS of) a certain channel/signal, and this RS may be referred to as a QCL source of QCL type X in the TCI state.

### Unified/Common TCI Framework

With a unified TCI framework, UL and DL channels can be controlled by a common framework. A unified TCI framework may indicate a common beam (common TCI state) and apply the common beam to all the UL and DL channels instead of defining a TCI state or a spatial relation for each channel as in Rel. 15, or apply a common beam for UL to all the UL channels while applying a common beam for DL to all the DL channels.

One common beam for both DL and UL or a common beam for DL and a common beam for UL (two common beams in total) are studied.

The UE may assume the same TCI state (joint TCI state, joint TCI pool, joint common TCI pool, joint TCI state set) for UL and DL. The UE may assume respective different TCI states (separate TCI states, separate TCI pools, UL separate TCI pool and DL separate TCI pool, separate common TCI pools, UL common TCI pool and DL common TCI pool) for UL and DL.

By beam management based on a MAC CE (MAC CE level beam indication), default UL and DL beams may be aligned. A default TCI state of a PDSCH may be updated to match to a default UL beam (spatial relation).

By beam management based on DCI (DCI level beam indication), a common beam/unified TCI state may be indicated from the same TCI pool (joint common TCI pool, joint TCI pool, set) for both UL and DL. X (>1) TCI states may be activated by a MAC CE. UL/DL DCI may select one from the X active TCI states. The selected TCI state may be applied to channels/RSs of both UL and DL.

The TCI pool (set) may be a plurality of TCI states configured by an RRC parameter or a plurality of TCI states (active TCI states, active TCI pool, set) activated by a MAC CE among the plurality of TCI states configured by the RRC parameter. Each TCI state may be a QCL type A/D RS. As the QCL type A/D RS, an SSB, a CSI-RS, or an SRS may be configured.

The number of TCI states corresponding to each of one or more TRPs may be defined. For example, the number N (≥1) of TCI states (UL TCI states) applied to UL channels/RSs and the number M (≥1) of TCI states (DL TCI states) applied to DL channels/RSs may be defined. At least one of N and M may be notified/configured/indicated to the UE via higher layer signaling/physical layer signaling.

In the present disclosure, description of N=M=X (X is any integer) may mean that X TCI states (joint TCI states) (corresponding to X TRPs) common to the UL and the DL are notified/configured/indicated to the UE. Description of N=X (X is any integer) and M=Y (Y is any integer and Y may be equal to X) may mean that X UL TCI states (corresponding to X TRPs) and Y DL TCI states (that is, separate TCI states) (corresponding to Y TRPs) are notified/configured/indicated to the UE.

For example, description of N=M=1 may mean that one TCI state common to the UL and the DL for a single TRP is notified/configured/indicated to the UE (joint TCI state for a single TRP).

For example, description of N=1 and M=1 may mean that one UL TCI state and one DL TCI state for a single TRP are separately notified/configured/indicated to the UE (separate TCI states for a single TRP).

For example, description of N=M=2 may mean that a plurality of (two) TCI states common to the UL and the DL for a plurality of (two) TRPs are notified/configured/indicated to the UE (joint TCI states for a plurality of TRPs).

For example, description of N=2 and M=2 may mean that a plurality of (two) UL TCI states and a plurality of (two) DL TCI states for a plurality of (two) TRPs are notified/configured/indicated to the UE (separate TCI states for a plurality of TRPs).

Note that, although the above examples describe cases in which the value of N and M is 1 or 2, the value of N and M may be 3 or greater, and N and M may be different.

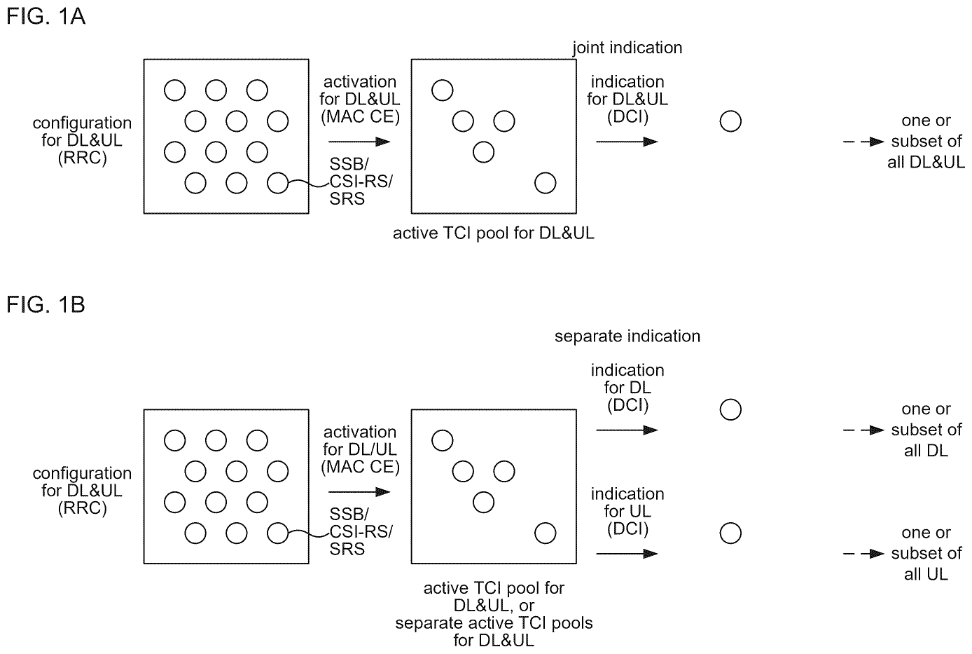

In the example in FIG. 1A, an RRC parameter (information element) configures a plurality of TCI states for both DL and UL. The MAC CE may activate a plurality of TCI states among the plurality of configured TCI states. DCI may indicate one of the plurality of activated TCI states. The DCI may be UL/DL DCI. The indicated TCI state may be applied to at least one (or all) of UL/DL channels/RSs. Single DCI may indicate both a UL TCI and a DL TCI.

In the example in the figure, one dot may be one TCI state applied to both UL and DL or may be two respective TCI states applied to UL and DL.

At least one of the plurality of TCI states configured by the RRC parameter and the plurality of TCI states activated by the MAC CE may be referred to as a TCI pool (common TCI pool, joint TCI pool, TCI state pool). The plurality of TCI states activated by the MAC CE may be referred to as an active TCI pool (active common TCI pool).

Note that, in the present disclosure, a higher layer parameter (RRC parameter) that configures a plurality of TCI states may be referred to as configuration information that configures a plurality of TCI states or simply as “configuration information.” In the present disclosure, one of a plurality of TCI states being indicated by using DCI may be receiving indication information indicating one of a plurality of TCI states included in DCI or may simply be receiving “indication information.”

In the example in FIG. 1B, an RRC parameter configures a plurality of TCI states for both DL and UL (joint common TCI pool). A MAC CE may activate a plurality of TCI states (active TCI pool) among the plurality of configured TCI states. Respective (different, separate) active TCI pools for UL and DL may be configured/activated.

DL DCI or a new DCI format may select (indicate) one or more (for example, one) TCI states. The selected TCI state(s) may be applied to one or more (or all) DL channels/RSs. The DL channel(s) may be a PDCCH/PDSCH/CSI-RS(s). The UE may determine the TCI state of each of the DL channels/RSs by using operation of a TCI state (TCI framework) of Rel. 16. UL DCI or a new DCI format may select (indicate) one or more (for example, one) TCI states. The selected TCI state(s) may be applied to one or more (or all) UL channels/RSs. The UL channel(s) may be a PUSCH/SRS PUCCH(s). Thus, different DCIs may indicate a UL TCI and a DL DCI separately.

Existing DCI format 1_1/1_2 may be used for indication of a common TCI state.

Beam indication DCI for the unified/common TCI state may be DCI format 1_1/1_2 with DL assignment (scheduling).

The beam indication DCI for the unified/common TCI state may be DCI format 1_1/1_2 without DL assignment (scheduling), or may be a new DCI format. This is useful for a case in which there is no DL data but is a beam indication for the unified/common TCI state.

A common TCI framework may include separate TCI states for DL and UL.

For M=N=1 in the separate DL/UL TCI of the unified TCI framework in Rel. 17, it has been studied that one instance of beam indication using DCI format 1_1/1_2 (with/without DL assignment) conforms to at least one of the following beam indications 1 to 3.
[Beam Indication 1] One TCI field code point represents a pair of a DL TCI state and a UL TCI state. If the DCI indicates such a TCI field code point, the UE applies a corresponding DL TCI state and UL TCI state.
[Beam Indication 2] One TCI field code point represents only a DL TCI state. If the DCI indicates such a TCI field code point, the UE applies a corresponding DL TCI state, and maintains a UL TCI state.
[Beam Indication 3] One TCI field code point represents only a UL TCI state. If the DCI indicates such a TCI field code point, the UE applies a corresponding UL TCI state, and maintains a DL TCI state.

In the present disclosure, a TCI state pool, a TCI state list, a unified TCI state pool, a joint TCI, a joint TCI state pool, a separate TCI state pool, a separate DL/UL TCI state pool, a DL TCI state pool, a UL TCI state pool, a separate DL TCI state pool, a separate UL TCI state pool, and a separate UL TCI may be interchangeably interpreted.

### Beam Indication DCI for Unified TCI

For the beam indication using the unified TCI of Rel. 17, it has been studied that the UE supports DCI format 1_1/1_2 (beam indication DCI) without DL assignment. As a mechanism of the ACK/NACK for the beam indication, a mechanism that is similar to the mechanism of the ACK/NACK for SPS PDSCH release using the type 1 and type 2 HARQ-ACK codebooks may be used.

In response to a success in reception of the beam indication DCI, the UE may report the ACK. In response to a failure in reception of the beam indication DCI, the UE may report the NACK.

For the type 1 HARQ-ACK codebook, the position of the ACK information in the HARQ-ACK codebook may be determined based on a virtual PDSCH indicated by a TDRA field in the beam indication DCI, based on a time domain assignment list configured for the PDSCH. For the type 2 HARQ-ACK codebook, the position of the ACK information in the HARQ-ACK codebook may be determined in accordance with the same rule as the rule for SPS release.

The ACK may be reported in the PUCCH that is k slots after the end of the PDCCH reception. Here, k may be indicated by a PDSCH-to-HARQ feedback timing indicator field in the DCI format, or if the PDSCH-to-HARQ feedback timing indicator field is not present in the DCI, k may be provided by dl-DataToUL-ACK or dl-DataToUL-ACK-ForDCIFormat1-2-r16.

When the DCI is used for the beam indication, a CS-RNTI may be used for scrambling of CRC for the DCI, and the DCI field may have the following values.
RV=all ‘1’
MCS=all ‘1’
NDI=0
all ‘0’ for FDRA type 0, or all ‘1’ for FDRA type 1, or all ‘0’ for dynamicSwitch

The following DCI fields may be used similarly to Rel. 16.
Identifier for DCI formats
Carrier indicator
Bandwidth part indicator
TDRA
Downlink assignment index (if configured)
TPC command for scheduled PUCCH
PUCCH resource indicator
PDSCH-to-HARQ feedback timing indicator (if present)

The rest of unused DCI fields and code points may be reserved in Rel. 17.

The UE may report whether or not to support TCI update using DCI format 1_1/1_2. The UE that supports TCI update using DCI format 1_1/1_2 may be required to support TCI update using DCI format 1_1/1_2 without DL assignment.

### HARQ-ACK of Multi-TRP

As Hybrid Automatic Repeat reQuest ACKnowledgement (HARQ-ACK) feedback for a multi-PDSCH, separate HARQ-ACK feedback and joint HARQ-ACK feedback have been under study. In the present disclosure, “separate” may be interchangeably interpreted as “independent.”

The separate HARQ-ACK feedback (which may be referred to as separate feedback or a separate HARQ-ACK) corresponds to feedback in which the UE transmits the HARQ-ACK using separate uplink control channel (Physical Uplink Control Channel (PUCCH))/uplink shared channel (Physical Uplink Shared Channel (PUSCH)) resources for each TRP. The plurality of PUCCH/PUSCH resources may overlap (may be simultaneously transmitted), or may not overlap (for example, may be subjected to TDM/FDM).

The use of the separate HARQ-ACK enables independent HARQ-ACK transmission for each TRP. Even when a backhaul delay among TRPs is large (for example, when TRPs are connected using a non ideal backhaul), delay of the HARQ is not increased.

The joint HARQ-ACK feedback (which may be referred to as joint feedback, a joint HARQ-ACK, or the like) corresponds to feedback in which the UE collectively transmits the HARQ-ACK of a plurality of TRPs using the same PUCCH/PUSCH resources.

The use of the joint HARQ-ACK enables reduction of resource overhead, because one PUCCH/PUSCH transmission suffices. When a backhaul delay among TRPs is small (for example, when TRPs are connected using an ideal backhaul), the HARQ-ACK that has been transmitted to one TRP can be delivered to another TRP with only a small delay.

In Rel-16 NR, the UE may be configured with a feedback mode, using a higher layer parameter (which may be referred to as “ackNackFeedbackMode”, “ackNackFeedbackMode-r16”, an ACKNACK feedback mode, or the like) indicating whether the feedback mode to be used in one slot is the joint feedback or the separate feedback.

One or a plurality of DCIs for scheduling the multi-PDSCH may include a field for a PUCCH resource indicator (PRI). The PRI corresponds to information for indicating resources for transmitting the HARQ-ACK corresponding to the PDSCH, and may be referred to as an ACK/NACK resource indicator (ARI).

The UE may determine PUCCH resource(s) for transmitting the HARQ-ACK corresponding to the multi-PDSCH, based on the PRI.

### HARQ-ACK Codebook

In NR, the UE may transmit HARQ-ACK feedback by using one PUCCH resource for each HARQ-ACK codebook, which consists of one or more transmission confirmation information (for example, Hybrid Automatic Repeat reQuest ACKnowledgement (HARQ-ACK)) bits. The HARQ-ACK bits may be referred to as HARQ-ACK information, HARQ-ACK information bits, or the like.

Here, the HARQ-ACK codebook may include bits for the HARQ-ACK in the unit of at least one of a time domain (for example, a slot), a frequency domain (for example, a component carrier (CC)), a spatial domain (for example, a layer), a transport block (TB), and a code block group (CBG) constituting the TB. The HARQ-ACK codebook may be simply referred to as a codebook.

Note that the number (size) of bits included in the HARQ-ACK codebook or the like may be determined semi-statically or dynamically. The HARQ-ACK codebook whose size is semi-statically determined is also referred to as a semi-static HARQ-ACK codebook, a type 1 HARQ-ACK codebo ok, or the like. The HARQ-ACK codebook whose size is dynamically determined is also referred to as a dynamic HARQ-ACK codebook, a type 2 HARQ-ACK codebook, or the like.

Which is used among the type 1 HARQ-ACK codebook and the type 2 HARQ-ACK codebook may be configured for the UE, using a higher layer parameter (for example, pdsch-HARQ-ACK-Codebook).

In a case of the type 1 HARQ-ACK codebook, in a certain range (for example, a range configured based on the higher layer parameter), the UE may feed the HARQ-ACK bits back for PDSCH candidates (or PDSCH occasions) corresponding to the range, regardless of whether or not there is scheduling of the PDSCH.

The range may be determined based on at least one of a certain period (for example, a set of a specific number of occasions for PDSCH reception as candidates, or a specific number of PDCCH monitoring occasions), the number of CCs configured or activated for the UE, the number of TBs (the number of layers or the rank), the number of CBGs per TB, and whether or not spatial bundling is applied. The range is also referred to as an HARQ-ACK window, an HARQ-ACK bundling window, an HARQ-ACK feedback window, or the like.

In the type 1 HARQ-ACK codebook, even if there is no scheduling of the PDSCH for the UE, the UE secures bits for the PDSCH within the codebook, on the condition that it is within the range. When the UE determines that the PDSCH is not actually scheduled, the UE can feed the bits back as NACK bits.

In a case of the type 1 HARQ-ACK codebook, the DCI need not include a DAI because an HARQ-ACK codebook size is fixed regardless of reception of the DCI/PDSCH. An index may be assigned to each HARQ-ACK bit (corresponding DCI/PDSCH) within the type 1 HARQ-ACK codebook for one TRP. The indices may be in ascending order of frequency (for example, serving cell (CC) index). The indices may be in ascending order of time (for example, PDCCH monitoring occasion) for the same frequency.

In contrast, in a case of the type 2 HARQ-ACK codebook, in the range, the UE may feed back the HARQ-ACK bits for the scheduled PDSCH.

Specifically, the UE may determine the number of bits of the type 2 HARQ-ACK codebook, based on a field (for example, a DL assignment index (Downlink Assignment Indicator (Index) (DAI)) field) in the DCI. The DAI field may include a counter DAI (C-DAI) and a total DAI (T-DAI).

The C-DAI may indicate a counter value of downlink transmission (PDSCH, data, TB) scheduled within a certain period. For example, the C-DAI in the DCI for scheduling data within the period may indicate a number that is counted first in the frequency domain (for example, the CC) and then in the time domain within the period. For example, the C-DAI may correspond to a value for counting PDSCH reception or semi-persistent scheduling release (Semi-Persistent Scheduling (SPS) release) in ascending order of the serving cell index and then in ascending order of the PDCCH monitoring occasion regarding one or more DCIs included in the period.

In other words, the C-DAI may mean a cumulative number of pairs of {serving cell, PDCCH monitoring occasion} corresponding to each piece of data up to the current serving cell and the current PDCCH monitoring occasion.

The T-DAI may indicate a total value (total number) of pieces of data scheduled within a certain period. For example, the T-DAI in the DCI for scheduling data in a certain time unit (for example, PDCCH monitoring occasion) within the period may indicate a total number of pieces of data scheduled up to the time unit (also referred to as a point, a timing, or the like) within the period.

In other words, the T-DAI may be a total number of pairs of {serving cell, PDCCH monitoring occasion} corresponding to each piece of data, which is a value updated for each PDCCH monitoring occasion, up to the current PDCCH monitoring occasion.

In a case of the type 2 HARQ-ACK codebook, with the DCI including the DAI, the base station and the UE can interpret the HARQ-ACK codebook size in common. Each HARQ-ACK bit (corresponding DCI/PDSCH) within the type 2 HARQ-ACK codebook for one TRP may be indexed. The indices may be in ascending order of time (for example, PDCCH monitoring occasion). The indices may be in ascending order of frequency (for example, serving cell (CC) index) for the same time.

Incidentally, in Rel-16 NR which has been studied thus far, CORESETs of different CORESET pool indices are respectively used for scheduling different PDSCHs (multi-DCI based multi-TRP).

Thus, in Rel-16 NR, when the UE is configured with a first CORESET and a second CORESET described above and the separate feedback is configured (“ackNackFeedbackMode-r16”=“separate” is configured), it is defined that the UE performs generation/reporting of the HARQ-ACK information related to the first CORESET and generation/reporting of the HARQ-ACK information related to the second CORESET separately regarding the type 1 and type 2 HARQ-ACK codebooks.

Note that, in the present disclosure, a “first TRP”, “TRP1”, a “first CORESET”, and a “CORESET not provided with the CORESET pool index or provided with CORESET pool index value=0” may be interchangeably interpreted. The “first CORESET” may mean one or a plurality of first CORESETs.

Note that, in the present disclosure, a “second TRP”, “TRP2”, a “second CORESET”, and a “CORESET provided with CORESET pool index value=1” may be interchangeably interpreted. The “second CORESET” may mean one or a plurality of second CORESETs.

On the other hand, two CORESETs related to two linked SS sets described above (in the present disclosure, also referred to as “two linked CORESETs for PDCCH repetition”) are used for repetition transmission of the DCI of the same payload. In other words, the two linked CORESETs may be used for scheduling of one same PDSCH.

### PUCCH Resource Determination for HARQ-ACK Information

For the PUCCH with the HARQ-ACK information, the UE determines a set of PUCCH resources for the number of HARQ-ACK information bits and then determines the PUCCH resources. PUCCH resource determination is based on a PUCCH resource indicator field in the last DCI format if there are a plurality of specific DCI formats. The plurality of specific DCI formats are a plurality of DCI formats having a value of a PDSCH-to-HARQ feedback timing indicator field, or dl-DataToUL-ACK, or dl-DataToUL-ACK-r16, or a value of dl-DataToUL-ACKForDCIFormat1-2 for indicating the same slot for PUCCH transmission, which are a plurality of DCI formats to be detected by the UE, and are a plurality of DCI formats for transmitting corresponding HARQ-ACK information in the PUCCH. In PUCCH resource determination, a plurality of detected specific DCI formats are first indexed in ascending order of the serving cell index for the same PDCCH monitoring occasion, and are subsequently indexed in ascending order of the PDCCH monitoring occasion index. In indexing of the plurality of DCI formats in one serving cell for the same PDCCH monitoring occasion index, if the UE is not provided with the CORESET pool index or is provided with the CORESET pool index with a value 0 for one or more first CORESETs and is provided with the CORESET pool index with a value 1 for one or more second CORESETs on an active DL BWP of one serving cell, and there is ackNackFeedbackMode=joint for an active UL BWP, the DCI formats detected from PDCCH reception in the first CORESET(s) are indexed prior to the DCI formats detected from PDCCH reception in the second CORESET(s).

### Beam Application Time (BAT)

In DCI-based beam indication in Rel. 17, regarding application time (BAT) of an indication of the beam/unified TCI state, the following studies 1 and 2 have been under study.

### Study 1

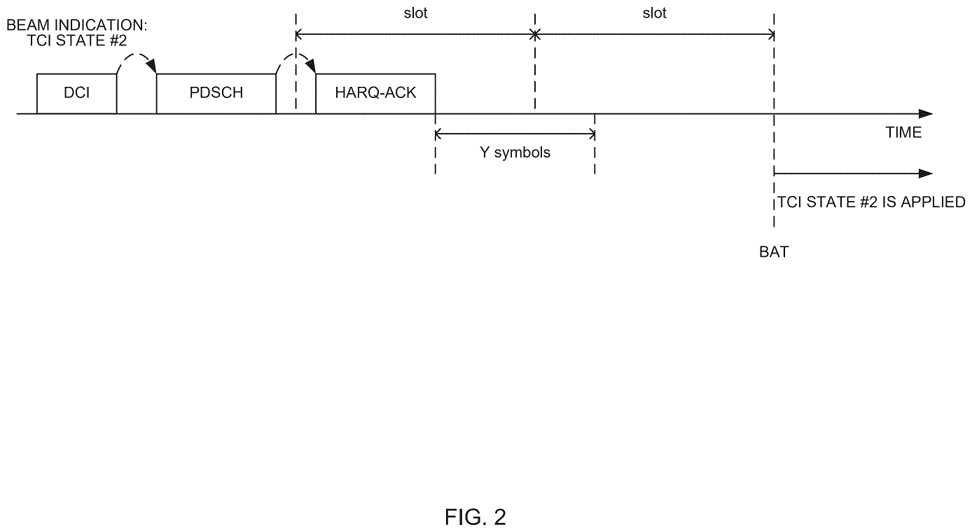

It has been studied that a first slot to which the indicated TCI is applied is at least Y symbols after the last symbol of a positive response (acknowledgement (ACK)) for the joint or separate DL/UL beam indication (FIG. 2). It has been studied that the first slot to which the indicated TCI is applied is at least Y symbols after the last symbol of an ACK/negative response (negative acknowledgement (NACK)) for the joint or separate DL/UL beam indication. The Y symbols may be configured by the base station, based on a UE capability. The UE capability may be reported for each symbol.

According to study 1, the BAT is determined based on Y symbols; however, when SCSs are different among a plurality of CCs, values of the Y symbols are also different, and thus the BATs are different among the plurality of CCs.

### Study 2

For a case of CA, the application time of the beam indication may conform to one of the following choices 1 to 3.
[Choice 1] Both of the first slot and the Y symbols are determined on a carrier with the smallest SCS among one or more carriers to which the beam indication is applied.
[Choice 2] Both of the first slot and the Y symbols are determined on a carrier with the smallest SCS among one or more carriers to which the beam indication is applied and a UL carrier for carrying the ACK.
[Choice 3] Both of the first slot and the Y symbols are determined on a UL carrier for carrying the ACK.

As a CC simultaneous beam update function of Rel. 17, it has been studied to make beams common among a plurality of CCs in CA. According to study 2, the BAT is made common among a plurality of CCs.

However, when the UE receives a plurality of DCIs related to the TCI state, how to determine the TCI state based on the plurality of DCIs is unclear. Unless an operation for the plurality of DCIs is clear, communication throughput may be reduced.

In view of this, the inventors of the present invention came up with the idea of a method of appropriately determining a TCI state, based on a plurality of DCIs.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C”.

In the present disclosure, activate, deactivate, indicate, select, configure, update, determine, and the like may be interchangeably interpreted. In the present disclosure, “support,” “control,” “can control,” “operate,” “cab operate”, and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, a TCI state, a common TCI state, a unified TCI state, a TCI state applicable to the DL and the UL, a TCI state applied to a plurality of (a plurality of types of) channels/RSs, a TCI state applicable to a plurality of types of channels/RSs, a joint TCI state of the DL and the UL, a TCI state of the UL and the DL for a joint TCI indication, a separate TCI state of the DL/UL, a TCI state of only the UL for a separate TCI indication, and a TCI state of only the DL for a separate TCI indication may be interchangeably interpreted.

In the present disclosure, a plurality of TCI states configured by RRC, a plurality of TCI states activated by a MAC CE, a pool, a TCI state pool, an active TCI state pool, a common TCI state pool, a joint TCI state pool, a separate TCI state pool, a common TCI state pool for the UL, a common TCI state pool for the DL, a common TCI state pool configured/activated by RRC/MAC CE, and TCI state information may be interchangeably interpreted.

In the present disclosure, a channel/RS to which the unified TCI is applied may be a PDCCH/PDSCH/HARQ-ACK information/PUCCH/PUSCH/CSI-RS/SRS.

In the present disclosure, DCI, a DCI format, a beam indication, beam indication DCI, TCI (state) indication DCI, DCI with a TCI indication (field), and DCI format 1_0/1_1/1_2 may be interchangeably interpreted.

In the present disclosure, the multi-DCI based multi-TRP, being configured with the CORESET pool index, and not being provided with the CORESET pool index or being provided with the CORESET pool index with a value 0 for one or more first CORESETs and being provided with the CORESET pool index with a value 1 for one or more second CORESETs on an active DL BWP of one serving cell may be interchangeably interpreted.

In the present disclosure, the single-DCI based multi-TRP, two TCI states being activated for one or more values (code points) of the TCI field, and not being configured with the CORESET pool index may be interchangeably interpreted.

### Radio Communication Method

In each embodiment, the unified TCI may be simply referred to as a TCI state, a beam, or the like. In other words, the TCI state in each embodiment may be applied to one or more types of channels/RSs.

In each embodiment, HARQ-ACK information corresponding to DCI, an ACK corresponding to DCI, UL transmission scheduled/triggered by DCI, HARQ-ACK information corresponding to a PDSCH scheduled by DCI, and UL transmission in a UL transmission timing indicated by DCI may be interchangeably interpreted. In each embodiment, UL transmission, HARQ-ACK information, an ACK, and a PUCCH/PUSCH/SRS may be interchangeably interpreted.

In each embodiment, a DCI format (specific DCI) with the TCI field may be a DCI format in which the TCI field is present (configured) among specified DCI formats. In each embodiment, the DCI format without the TCI field may be a DCI format except for a specified DCI format with the TCI field, may include DCI format 1_0, or may include a specified DCI format without the TCI field. The specified DCI format may include DCI format 1_1/1_2, may include a group common DCI format (for example, DCI format 2_x), or may include a UL grant DCI format (for example, DCI format 0_x). The specified DCI format may be at least one of a DCI format with DL assignment and a DCI format without DL assignment.

In each embodiment, a DCI format with the TCI field, a DCI format for indicating the TCI state, beam indication DCI, TCI state indication DCI, and specific DCI may be interchangeably interpreted. In each embodiment, target DCI may be one or more specific DCIs.

In each embodiment, at or after a specific timing based on the target DCI for indicating the TCI state, the UE may apply the TCI state. The specific timing may be Y symbols after reception of the target DCI, may be Y symbols after the last symbol of reception of the target DCI, may be the first slot that is at least Y symbols after the last symbol of reception of the target DCI, may be the first slot that is at least Y symbols after the last symbol of transmission of an ACK for the target DCI, may be the first slot that is at least Y symbols after the last symbol of transmission of an ACK/NACK for the target DCI, or may be the first slot that is at least Y symbols after the last symbol of UL transmission for the target DCI.

Y may be given by a beam application time (BAT, for example, BeamAppTime r17) of an RRC parameter. For CA, Y may be based on the smallest subcarrier spacing (SCS) among CCs (cells) to which the beam is applied.

The target DCI may be a DCI format without DL assignment, or may be a DCI format with DL assignment.

The UE may transmit an ACK/NACK for a DCI format without DL assignment for indicating a beam. The UE may update the indicated beam (TCI state) at a specific timing after transmission of the ACK.

The UE may transmit an ACK/NACK for a PDSCH scheduled by a DCI format to the DCI format with DL assignment for indicating a beam. The UE may update the indicated beam (TCI state) at a specific timing after transmission of the ACK.

The UE may transmit an ACK/NACK to a DCI format with DL assignment for indicating a beam. The UE may update the indicated beam (TCI state) at a specific timing after transmission of the ACK.

When the UE transmits the HARQ-ACK codebook for a plurality of PDSCHs based on a plurality of DCIs on one PUSCH/PUCCH, the UE may determine a beam, based on one or more specific DCIs (beam indications, TCI state indications, TCI fields, QCL assumptions) among the plurality of DCIs. The UE may apply the beam indicated by the specific DCI(s) at a specific timing after HARQ-ACK codebook transmission.

The UE may select/determine one or more specific DCIs among the plurality of DCIs, considering at least one of a magnitude relationship of values of resources/indices in the time domain, a magnitude relationship of values of resources/indices in the frequency domain, and a magnitude relationship of values of indices of the TRPs/CORESET pools.

The UE may index a plurality of DCIs in accordance with specific parameter(s), and select/determine the last DCI in the index order as the specific DCI (the TCI state in the DCI may be used for indication/update). The specific parameter(s) may be at least one of the following parameters corresponding to respective DCIS/PDSCHs.
Bit position in the semi-static (type 1)/dynamic (type 2) HARQ-ACK codebook
Index for determining the last DCI for PUCCH resource determination
Time (for example, a PDCCH monitoring occasion, a slot)
Frequency (for example, a serving cell index)
TRP (for example, a TRP ID/CORESET pool index)

In indexing, order of priority of the plurality of specific parameters may be defined. The order of priority may be one of the following.
Time, frequency, TRP
Time, TRP, frequency
Frequency, time, TRP
Frequency, TRP, time
TRP, time, frequency
TRP, frequency, time

When the order of priority is in order of a first parameter, a second parameter, and a third parameter, the plurality of DCIs are indexed in ascending order or descending order of the first parameter. The plurality of DCIs with the same value of the first parameter are indexed in ascending order or descending order of the second parameter. The plurality of DCIs with the same value of the first parameter and the same value of the second parameter are indexed in ascending order or descending order of the third parameter.

For example, the plurality of DCIs are indexed in ascending order of time (for example, the PDCCH monitoring occasion index), the plurality of DCIs with the same time are indexed in ascending order of frequency (for example, the serving cell index), and the plurality of DCIs with the same value of time and the same value of frequency are indexed in ascending order of the TRP (for example, the CORESET pool index).

The UE may index a plurality of PDSCHs based respectively on a plurality of DCIs in accordance with the specific parameter(s), and select/determine the DCI corresponding to the last PDSCH in the indices as the specific DCI (the TCI state in the DCI may be used for indication/update). The specific parameter(s) corresponding to the DCI described above may be used as the specific parameter(s) corresponding to respective PDSCHs. In indexing, the order of priority of the plurality of specific parameters may be defined. The order of priority of the specific parameters for indexing of the DCIs described above may be used as the order of priority of the specific parameters for indexing of the PDSCHS.

### First Embodiment

The present embodiment relates to a method of determining the unified TCI state in the single TRP.

In the single TRP, the UE may determine a beam, based on specific DCI corresponding to a specific HARQ-ACK information bit in the HARQ-ACK codebook. The single TRP may be at least one of a case in which the CORESET pool index is not configured for the CORESET and a case in which one TCI state is not associated with one code point of the TCI field.

### Aspect 1-1

For the semi-static (type 1) HARQ-ACK codebook, the specific HARQ-ACK information bit may be the last HARQ-ACK information bit in the HARQ-ACK codebook in which a plurality of HARQ-ACK information bits are put.

For the semi-static HARQ-ACK codebook, DCI corresponding to the last HARQ-ACK information bit is not necessarily received. For the semi-static HARQ-ACK codebook, the UE generates the HARQ-ACK information bits, regardless of whether there is reception of DCI. In view of this, instead of the DCI corresponding to the last HARQ-ACK information bit, the specific DCI may be DCI corresponding to the last ACK in the HARQ-ACK codebook, or may be the last DCI among the DCIs corresponding to the ACK in the HARQ-ACK codebook and for performing beam indication.

Order of the HARQ-ACK information bits in the semi-static HARQ-ACK codebook, order of the indices given to the PDSCHs, and order of the indices given to the DCIs may be interchangeably interpreted.

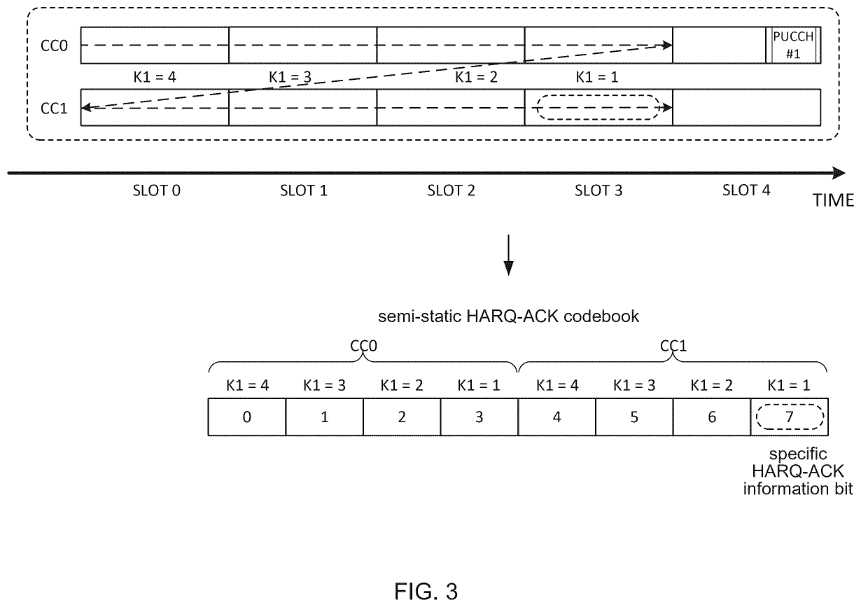

In the example of FIG. 3, the DCI indicates a beam indication/PDSCH scheduling/HARQ-ACK timing (a slot K1 from PDSCH reception up to HARQ-ACK transmission). The HARQ-ACK timings for the DCI/PDSCH in each of slots #0, #1, #2, and #3 of CC #0 are at the same slot #4, and the HARQ-ACK timings for the DCI/PDSCH in each of slots #0, #1, #2, and #3 of CC #1 are at the same slot #4.

A plurality of HARQ-ACK information bits in the semi-static HARQ-ACK codebook may be indexed in order of frequency (CC index/serving cell index) of a corresponding PDSCH/DCI. The plurality of HARQ-ACK information bits corresponding to the PDSCH/DCI of the same frequency may be indexed in order of time (slot/PDCCH monitoring occasion index) of the corresponding PDSCH/DCI.

In the HARQ-ACK codebook, the plurality of HARQ-ACK information bits may be mapped in order of their indices (HARQ-ACK information bits #0 to #7). The specific HARQ-ACK information bit may be last HARQ-ACK information bit #7 (in the index order) in the HARQ-ACK codebook.

### Aspect 1-2

For the dynamic (type 2) HARQ-ACK codebook, the specific HARQ-ACK information bit may be the last HARQ-ACK information bit in the HARQ-ACK codebook in which a plurality of HARQ-ACK information bits are put.

For the dynamic HARQ-ACK codebook, DCI corresponding to the last HARQ-ACK information bit is received. For the dynamic HARQ-ACK codebook, DCI corresponding to the last HARQ-ACK information bit is not necessarily used for performing beam indication. For example, DCI format 1_0 or DCI format 1_1/1_2 in which the TCI field is not present (the TCI field (tci-PresentInDCI) is not configured) need not include a beam indication. In view of this, instead of the DCI corresponding to the last HARQ-ACK information bit, the specific DCI may be the last DCI among the DCIs corresponding to the ACK in the HARQ-ACK codebook and for performing TCI indication.

Order of the HARQ-ACK information bits in the dynamic HARQ-ACK codebook, order of the indices given to the PDSCHs, and order of the indices given to the DCIs may be interchangeably interpreted.

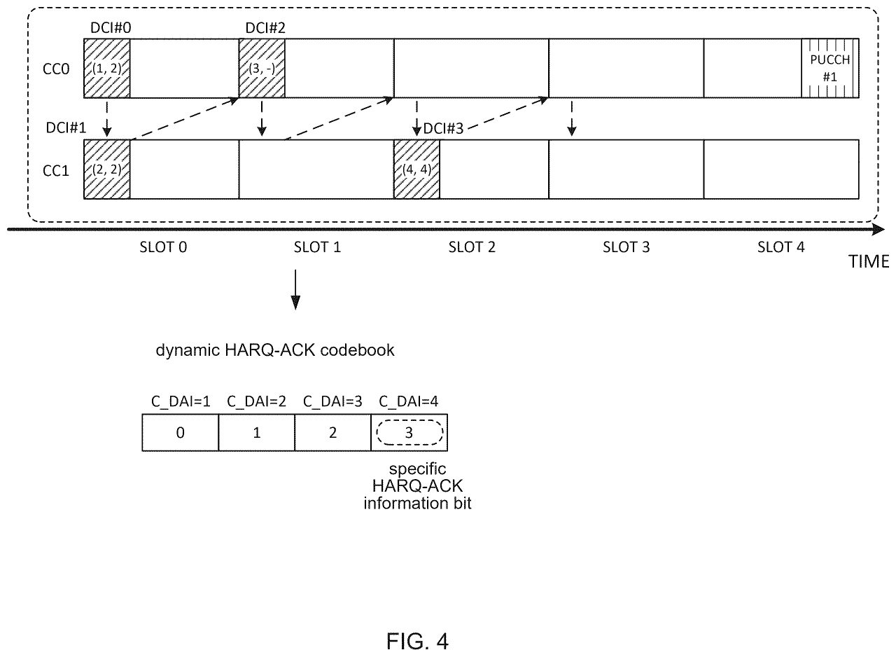

In the example of FIG. 4, each DCI includes (counter DAI, total DAI). The DCIs/PDSCHs (DCIs #0, #1, #2, and #3) are transmitted respectively in slot #0 of CC #0, slot #0 of CC #1, slot #1 of CC #0, and slot #2 of CC #1.

A plurality of HARQ-ACK information bits in the dynamic HARQ-ACK codebook may be indexed in order of time (slot/PDCCH monitoring occasion index) of a corresponding PDSCH/DCI, and the plurality of HARQ-ACK information bits corresponding to the PDSCH/DCI of the same time may be indexed in order of frequency (CC index, serving cell index) of the corresponding PDSCH/DCI (order of DCIs #0 to #3).

In the HARQ-ACK codebook, the plurality of HARQ-ACK information bits may be mapped in order of their indices (HARQ-ACK information bits #0 to #3). The specific HARQ-ACK information bit may be last HARQ-ACK information bit #3 (in the index order) in the HARQ-ACK codebook.

### Aspect 1-3

For DCI in which the TCI field is not present (DCI format 1_0, or DCI format 1_1/1_2 in which the TCI field (tci-PresentInDCI) is not configured), the DCI may conform to one of the following DCIs 1 and 2.

### DCI 1

It may be defined that a beam is not indicated by the DCI. The UE may conform to one of the following operations A and B.

### Operation A

The UE may determine specific DCI based on a rule except for the DCI, and apply beam indication of the specific DCI at a specific timing.

With the determination rule, the last DCI among the DCIs corresponding to the ACK in the HARQ-ACK codebook and including the TCI field may be determined as the specific DCI. With the determination rule, DCI corresponding to the last ACK in the HARQ-ACK information bit corresponding to the DCI including the TCI field among the HARQ-ACK information bits in the HARQ-ACK codebook may be determined as the specific DCI.

### Operation B

The UE may assume that a beam is not indicated by the DCI, and need not update the beam. When the specific DCI is the DCI, the UE may assume that a beam is not indicated by the DCI, and need not update the beam.

[DCI 2]

A beam may be indicated by the DCI. For example, it may be considered that QCL assumption for the DCI is a beam indicated by the DCI. The QCL assumption for the DCI may be at least one of a TCI state configured/indicated for the CORESET of the DCI, an SSB index identified at the time of the latest PRACH transmission, and a TCI state used for reception of the PDCCH/CORESET of the DCI.

### Aspect 1-4

When the specific DCI corresponding to the NACK (when the HARQ-ACK information bit corresponding to the specific DCI is the NACK), the UE may conform to one of the following operations A and B.

### Operation A

The UE may determine specific DCI based on a determination rule except for the DCI, and apply beam indication of the specific DCI at a specific timing.

With the determination rule, the last DCI among the DCIs corresponding to the ACK in the HARQ-ACK codebook and including the TCI field may be determined as the specific DCI. With the determination rule, DCI corresponding to the last ACK in the HARQ-ACK information bit corresponding to the DCI including the TCI field among the HARQ-ACK information bits in the HARQ-ACK codebook may be determined as the specific DCI. The DCI corresponding to the last ACK in the HARQ-ACK codebook may be determined as the specific DCI.

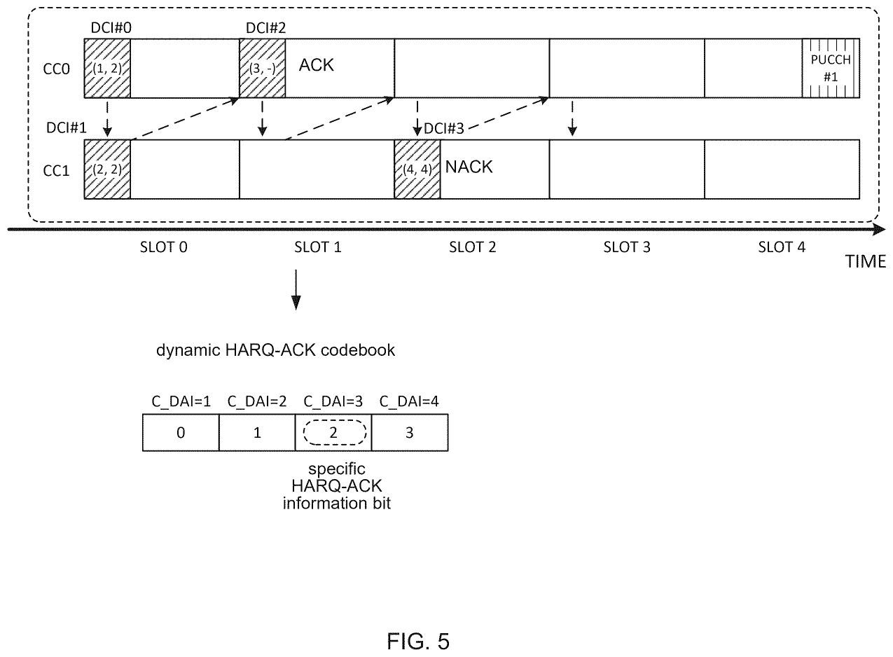

FIG. 5 shows an example of a dynamic HARQ-ACK codebook similar to that of FIG. 4. In the example, last HARQ-ACK information bit #3 in the HARQ-ACK codebook is the NACK, and HARQ-ACK information bit #2 being the last ACK in the HARQ-ACK codebook is the ACK. When the DCI corresponding to the last ACK in the HARQ-ACK codebook is determined as the specific DCI with the determination rule, the specific DCI is DCI #2 corresponding to HARQ-ACK information bit #2.

### Operation B

The UE may assume that a beam is not indicated by the DCI, and need not update the beam. When the specific DCI is the DCI, the UE may assume that a beam is not indicated by the DCI, and need not update the beam.

Aspect 1-3 may be applied to at least one of the semi-static HARQ-ACK codebook and the dynamic HARQ-ACK codebook.

According to the present embodiment, even when a plurality of DCIs for the single TRP are transmitted, the UE can appropriately determine the TCI state.

### Second Embodiment

The present embodiment relates to a method of determining the unified TCI state in the multi-TRP.

In the multi-TRP, the UE may determine a beam, based on specific DCI (beam indication, TCI state, TCI field) corresponding to a specific HARQ-ACK information bit in the HARQ-ACK codebook (may apply the beam indicated by the specific DCI at a specific timing).

### Aspect 2-1

In the multi-DCI based multi-TRP, the UE may determine a beam, based on specific DCI corresponding to a specific HARQ-ACK information bit in the HARQ-ACK codebook. The multi-DCI based multi-TRP may be a case in which the CORESET pool index is configured for the CORESET. For at least one of the separate HARQ-ACK codebook (when ackNackFeedbackMode =separate is configured) and the joint HARQ-ACK codebook (when ackNackFeedbackMode=joint is configured), the UE may determine a beam, based on specific DCI corresponding to a specific HARQ-ACK information bit in the HARQ-ACK codebook.

### Aspect 2-1-1

When the CORESET pool index is configured and the separate HARQ-ACK codebook is configured, the UE may determine a beam, based on specific DCI corresponding to a specific HARQ-ACK information bit in the HARQ-ACK codebook.

### Beam Determination Method A

The UE may determine two specific DCIs respectively corresponding to two CORESET pool indices. Each specific DCI may indicate the TCI state (for example, one of the joint TCI state of the DL and the UL, the UL TCI state, and the DL TCI state) of a corresponding TRP (CORESET pool index). Two specific DCIs respectively corresponding to two TRPs may indicate the TCI states respectively corresponding to the two TRPs.

The DCI/PDSCH corresponding to a corresponding CORESET pool index among the DCIs/PDSCHs corresponding to the HARQ-ACK information bit in the HARQ-ACK codebook may be indexed in accordance with the specific parameter(s), and the specific DCI may be the last DCI in the index order (the DCI corresponding to the last index). The specific DCI may be the DCI (to be referred to) corresponding to the PUCCH resource indicator (PRI) field/control channel element (CCE) index used for PUCCH resource determination.

Two HARQ-ACK codebooks to be generated may respectively correspond to two TRPs (CORESET pool indices). Two PUCCH resources subjected to TDM may respectively correspond to the two TRPs. The two HARQ-ACK codebooks may be transmitted respectively using the two PUCCH resources.

The semi-static HARQ-ACK codebook (Aspect 1-1) may be applied.

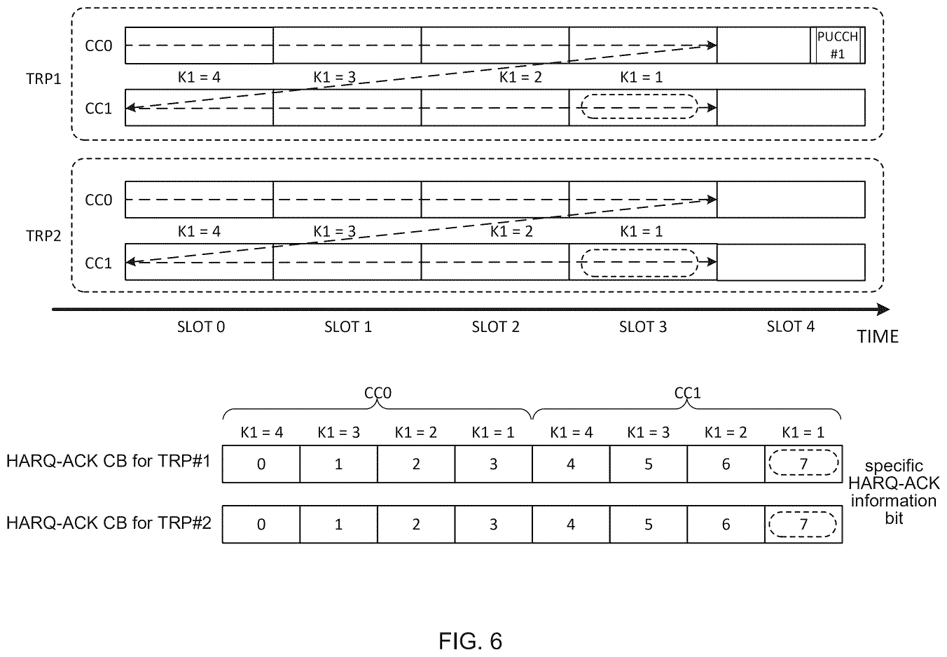

In the example of FIG. 6, the separate HARQ-ACK codebook and the semi-static HARQ-ACK codebook are configured.

For each TRP (CORESET pool index), a plurality of HARQ-ACK information bits in the semi-static HARQ-ACK codebook may be indexed in order of frequency (CC index/serving cell index) of a corresponding PDSCH/DCI. The plurality of HARQ-ACK information bits corresponding to the PDSCH/DCI of the same frequency may be indexed in order of time (slot/PDCCH monitoring occasion index).

In each HARQ-ACK codebook, the plurality of HARQ-ACK information bits may be mapped in the index order. Each specific HARQ-ACK information bit may be the last HARQ-ACK information bit (in the index order) in each HARQ-ACK codebook.

The dynamic HARQ-ACK codebook (Aspect 1-2) may be applied.

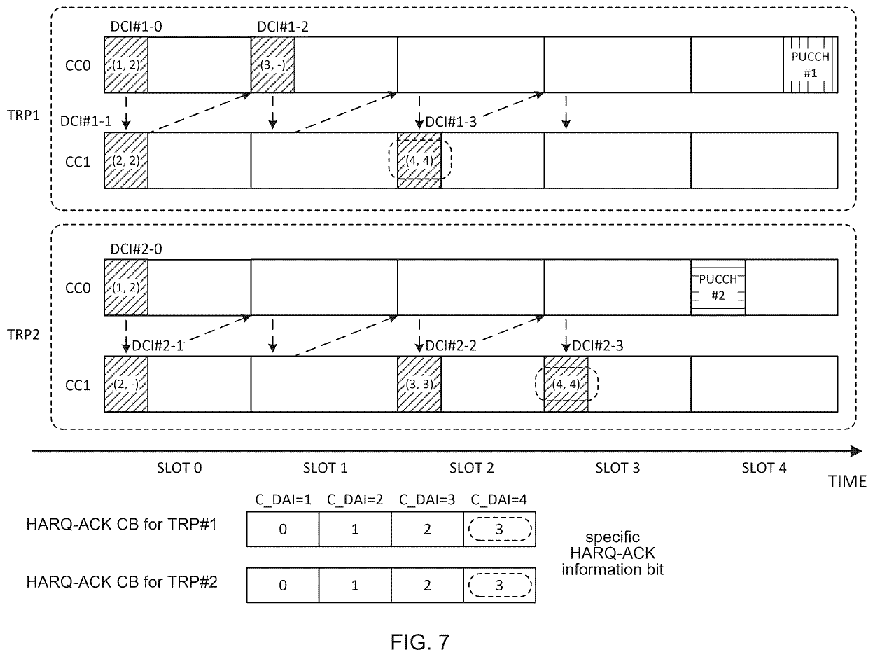

In the example of FIG. 7, the separate HARQ-ACK codebook and the dynamic HARQ-ACK codebook are configured.

For each TRP (CORESET pool index), a plurality of HARQ-ACK information bits in the dynamic HARQ-ACK codebook may be indexed in order of time (slot/PDCCH monitoring occasion index) of a corresponding PDSCH/DCI, and the plurality of HARQ-ACK information bits corresponding to the PDSCH/DCI of the same time may be indexed in order of frequency (CC index, serving cell index). In the example, HARQ-ACK information bit indices for TRP #1 may correspond in order of DCIs #1-0, #1-1, #1-2, and #1-3. The HARQ-ACK information bit indices for TRP #2 may correspond in order of DCIs #2-0, #2-1, #2-2, and #2-3.

In each HARQ-ACK codebook, the plurality of HARQ-ACK information bits may be mapped in the index order. Each specific HARQ-ACK information bit may be the last HARQ-ACK information bit (in the index order) in each HARQ-ACK codebook.

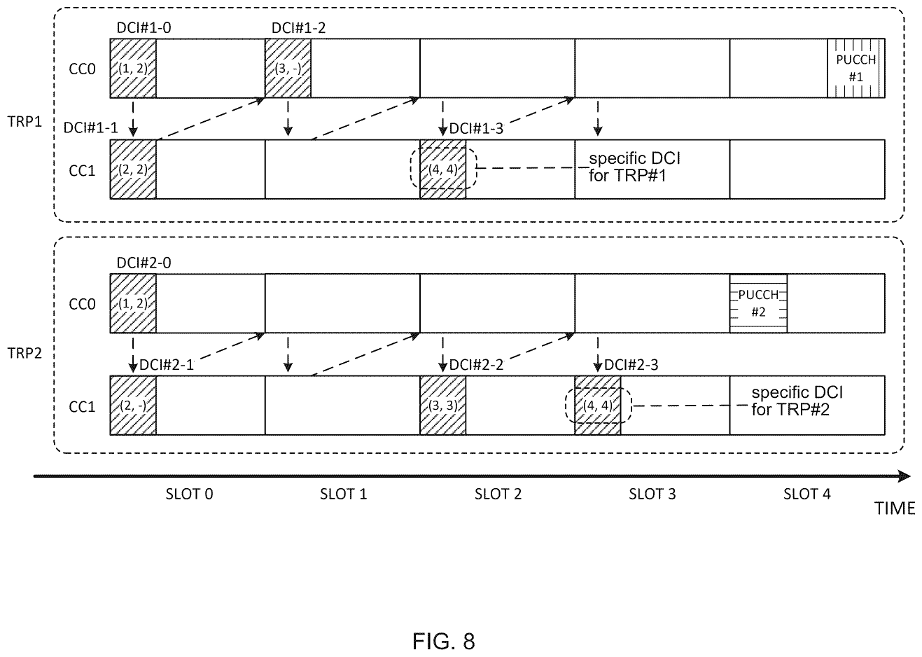

In the example of FIG. 8, the separate HARQ-ACK codebook and the dynamic HARQ-ACK codebook are configured.

For each TRP (CORESET pool index), the DCI/PDSCH corresponding to a plurality of HARQ-ACK information bits in the HARQ-ACK codebook may be indexed in order of time (slot/PDCCH monitoring occasion index). The PDSCH/DCI of the same time may be indexed in order of frequency (CC index/serving cell index). In the example, DCI indices for TRP #1 may be in order of DCIs #1-0, #1-1, #1-2, and #1-3. The DCI indices for TRP #2 may be in order of DCIs #2-0, #2-1, #2-2, and #2-3.

The specific DCI may be the last DCI (or the DCI corresponding to the last PDSCH) in the index order.

### Beam Determination Method B

The UE may determine one specific DCI corresponding to one specific CORESET pool index in two CORESET pool indices. The specific DCI may indicate the TCI state (for example, one of the joint TCI state of the DL and the UL, the UL TCI state, and the DL TCI state) of all of the TRPs (all of the CORESET pool indices). One specific DCI may indicate the TCI state corresponding to all of the TRPs.

The DCI/PDSCH corresponding to a specific coreset pool index among the DCIs/PDSCHs corresponding to the HARQ-ACK information bit in the HARQ-ACK codebook may be indexed in accordance with the specific parameter(s), and the specific DCI may be the last DCI in the index order (the DCI corresponding to the last index). The specific DCI may be the DCI (to be referred to) corresponding to the PRI field/CCE index used for PUCCH resource determination.

The DCI/PDSCH corresponding to all of the CORESET pool indices among the DCIs/PDSCHs corresponding to the HARQ-ACK information bit in the HARQ-ACK codebook may be indexed in accordance with the specific parameter(s), and the specific DCI may be the last DCI in the index order (the DCI corresponding to the last index). The specific DCI may be the DCI (to be referred to) corresponding to the PRI field/CCE index used for PUCCH resource determination.

The specific CORESET pool index may be 0, or may be 1.

In the examples of FIG. 6 and FIG. 7 described above, in each HARQ-ACK codebook, the plurality of HARQ-ACK information bits may be mapped in the index order. The specific HARQ-ACK information bit may be the last HARQ-ACK information bit (in the index order) in the HARQ-ACK codebook corresponding to the specific CORESET pool index.

In the example of FIG. 8 described above, the specific DCI may be the last DCI in the index order of the DCI corresponding to the specific CORESET pool index.

### Aspect 2-1-2

When the CORESET pool index is configured and the joint HARQ-ACK codebook is configured, the UE may determine a beam, based on specific DCI corresponding to a specific HARQ-ACK information bit in the HARQ-ACK codebook.

The UE may determine one specific DCI corresponding to one specific CORESET pool index in two CORESET pool indices. The specific DCI may indicate the TCI state (for example, one of the joint TCI state of the DL and the UL, the UL TCI state, and the DL TCI state) of a corresponding TRP (CORESET pool index). One specific DCI corresponding to a specific TRP (specific CORESET pool index) may indicate the TCI state corresponding to the specific TRP.

The DCI/PDSCH corresponding to a specific CORESET pool index among the DCIs/PDSCHs corresponding to the HARQ-ACK information bit in the HARQ-ACK codebook may be indexed in accordance with the specific parameter(s), and the specific DCI may be the last DCI in the index order (the DCI corresponding to the last index). The specific DCI may be the DCI (to be referred to) corresponding to the PRI field/CCE index used for PUCCH resource determination.

The DCI/PDSCH corresponding to all of the CORESET pool indices among the DCIs/PDSCHs corresponding to the HARQ-ACK information bit in the HARQ-ACK codebook may be indexed in accordance with the specific parameter(s), and the specific DCI may be the last DCI in the index order (the DCI corresponding to the last index). The specific DCI may be the DCI (to be referred to) corresponding to the PRI field/CCE index used for PUCCH resource determination.

The specific CORESET pool index may be 0, or may be 1.

One HARQ-ACK codebook to be generated may correspond to two TRPs (CORESET pool indices).

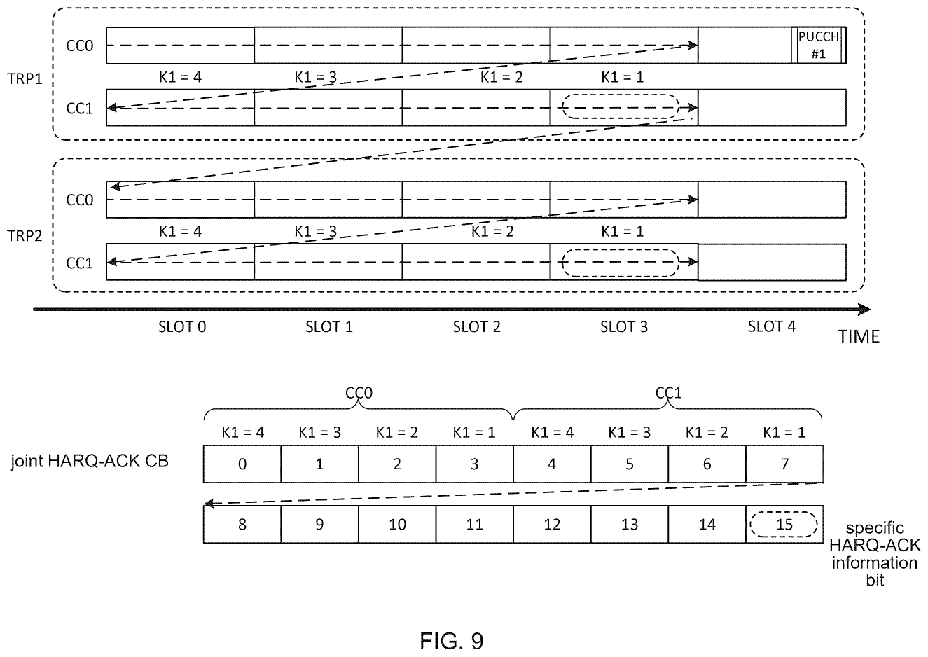

In the example of FIG. 9, the joint HARQ-ACK codebook and the semi-static HARQ-ACK codebook are configured.

A plurality of HARQ-ACK information bits in the HARQ-ACK codebook may be indexed in order of the TRP (CORESET pool index) of a corresponding PDSCH/DCI. The plurality of HARQ-ACK information bits corresponding to the PDSCH/DCI of the same TRP may be indexed in order of frequency (CC index/serving cell index). The plurality of HARQ-ACK information bits corresponding to the PDSCH/DCI of the same frequency may be indexed in order of time (slot/PDCCH monitoring occasion index).

In the HARQ-ACK codebook, the plurality of HARQ-ACK information bits may be mapped in the index order. The specific HARQ-ACK information bit may be the last HARQ-ACK information bit (in the index order) in the HARQ-ACK codebook.

The dynamic HARQ-ACK codebook (Aspect 1-2) may be applied.

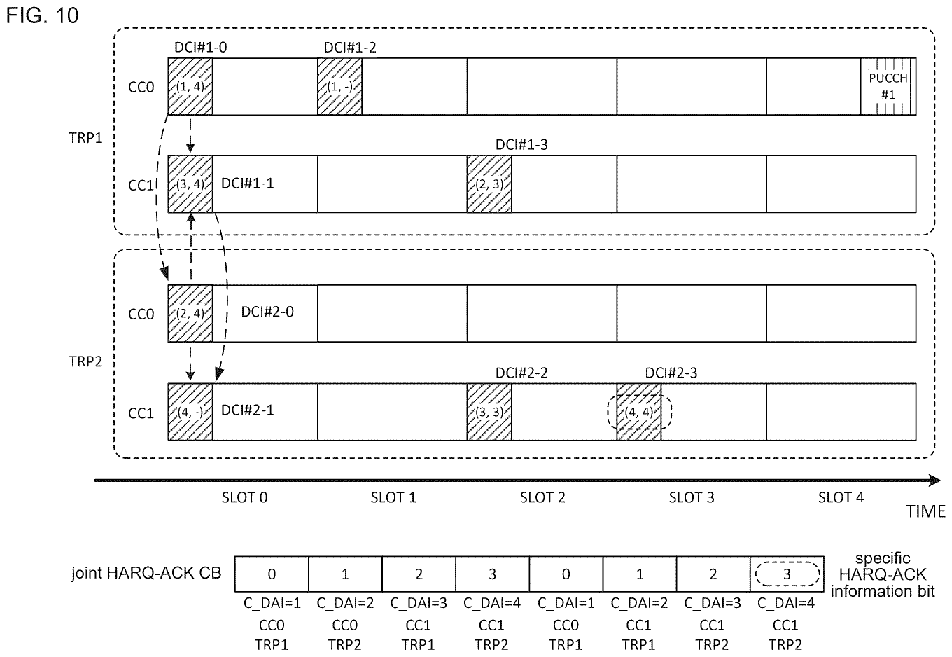

In the example of FIG. 10, the joint HARQ-ACK codebook and the dynamic HARQ-ACK codebook are configured.

The counter DAI in each DCI corresponding to the HARQ-ACK codebook may be counted across two TRPs. The total DAI in each DCI corresponding to the HARQ-ACK codebook may be a total number of DCIs in certain time (slot/PDCCH monitoring occasion) across two TRPs and a plurality of CCs.

A plurality of HARQ-ACK information bits in the HARQ-ACK codebook may be indexed in order of time (slot/PDCCH monitoring occasion index) of a corresponding PDSCH/DCI. The plurality of HARQ-ACK information bits corresponding to the PDSCH/DCI of the same time may be indexed in order of frequency (CC index/serving cell index) of the corresponding PDSCH/DCI. The plurality of HARQ-ACK information bits corresponding to the PDSCH/DCI of the same frequency may be indexed in order of the TRP (CORESET pool index) of the corresponding PDSCH/DCI. In the example, the HARQ-ACK information bit indices may correspond in order of DCIs #1-0, #2-0, #1-1, #2-1, #1-2, #1-3, #2-2, and #2-3.

In the HARQ-ACK codebook, the plurality of HARQ-ACK information bits may be mapped in the index order. The specific HARQ-ACK information bit may be the last HARQ-ACK information bit (in the index order) in the HARQ-ACK codebook.

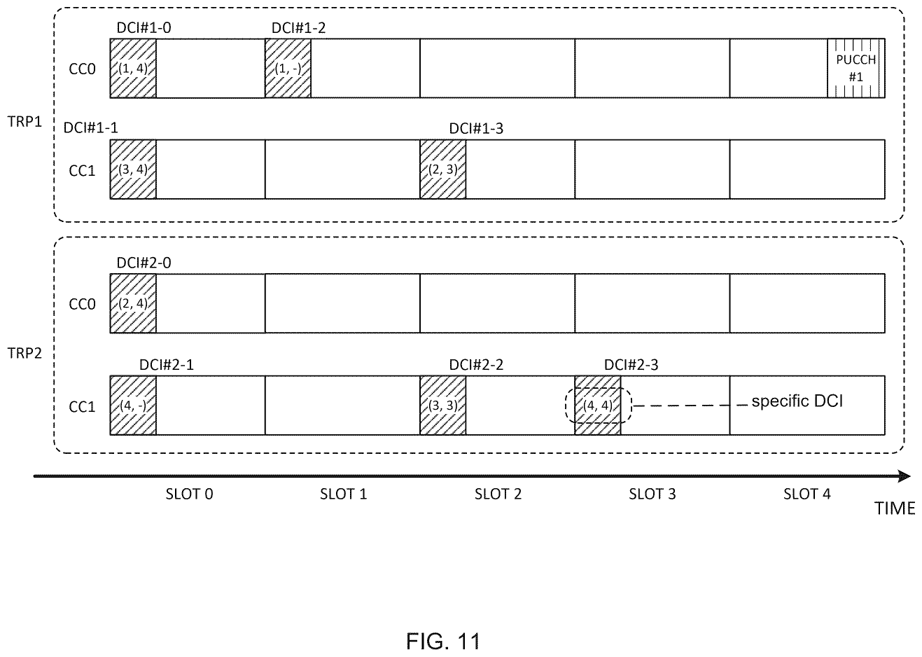

In the example of FIG. 11, the joint HARQ-ACK codebook and the dynamic HARQ-ACK codebook are configured.

The DCI/PDSCH corresponding to a plurality of HARQ-ACK information bits in the HARQ-ACK codebook may be indexed in order of time (slot/PDCCH monitoring occasion index). The PDSCH/DCI of the same time may be indexed in order of frequency (CC index/serving cell index). The PDSCH/DCI of the same frequency may be indexed in order of the TRP (CORESET pool index). In the example, DCI bit indices may be in order of DCIs #1-0, #2-0, #1-1, #2-1, #1-2, #1-3, #2-2, and #2-3.

The specific DCI may be the last DCI (or the DCI corresponding to the last PDSCH) in the index order.

### Aspect 2-1-3

The specific DCI may indicate a plurality of TCI states (N UL TCI states and M DL TCI states, N>1, M>1). In the multi-TRP, the single TRP, inter-band CA, and the like, the specific DCI may indicate a plurality of TCI states.

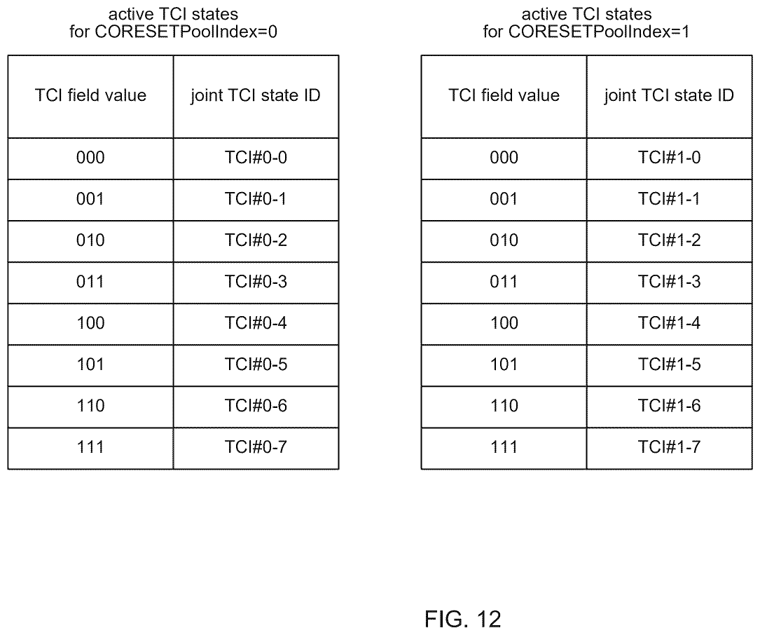

In the example of FIG. 12, two specific DCIs in the multi-DCI based multi-TRP respectively indicate two joint TCI states.

For CORESET pool index #0, the joint TCI state for each value (code point) of the TCI field may be activated by a MAC CE. For CORESET pool index #1, the joint TCI state for each value (code point) of the TCI field may be activated by a MAC CE. The TCI field in the specific DCI corresponding to CORESET pool index #0 may indicate one of a plurality of active joint TCI states. The TCI field in the specific DCI corresponding to CORESET pool index #1 may indicate one of a plurality of active joint TCI states.

The UE may apply the joint TCI state indicated by the specific DCI corresponding to CORESET pool index #0 to the DL and the UL corresponding to CORESET pool index #0. The UE may apply the joint TCI state indicated by the specific DCI corresponding to CORESET pool index #1 to the DL and the UL corresponding to CORESET pool index #1.

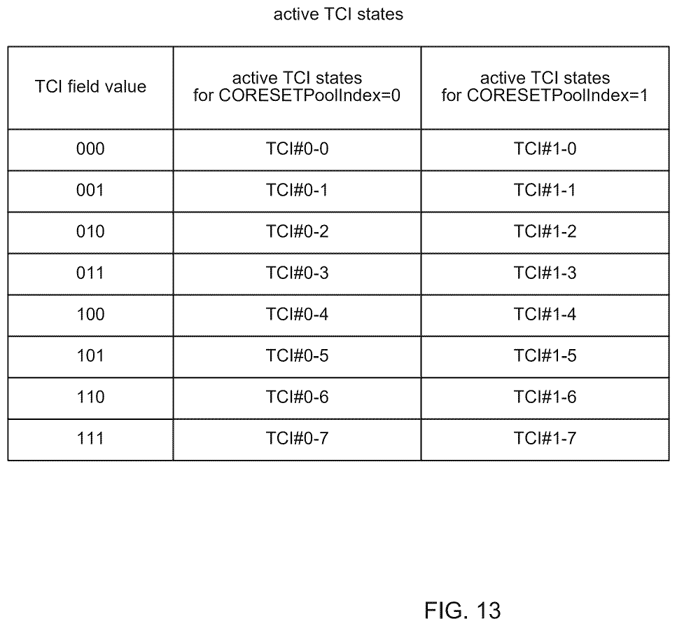

In the example of FIG. 13, one specific DCI in the multi-DCI based multi-TRP indicates two joint TCI states.

For each value (code point) of the TCI field, the joint TCI state for CORESET pool index #0 and the joint TCI state for CORESET pool index #1 may be activated by a MAC CE. The TCI field in one specific DCI may indicate one of the joint TCI state for CORESET pool index #0 and the joint TCI state for CORESET pool index #1. The TCI field in the specific DCI corresponding to CORESET pool index #1 may indicate one of a plurality of active TCI states.

The UE may apply the joint TCI state for CORESET pool index #0 and the joint TCI state for CORESET pool index #1 indicated by one specific DCI respectively to the DL and the UL corresponding to CORESET pool index #0 and the DL and the UL corresponding to CORESET pool index #1.

In these examples, indication of the joint TCI state may be interpreted as indication of the separate TCI state. In this case, one joint TCI state may be interpreted as at least one of the DL TCI state and the UL TCI state in the separate TCI state.

In these examples, the multi-DCI based multi-TRP may be interpreted as inter-band CA. In this case, CORESET pool indices #0 and #1 may be interpreted as bands #0 and #1.

### Aspect 2-2

In the single-DCI based multi-TRP, the UE may determine a beam, based on specific DCI corresponding to a specific HARQ-ACK information bit in the HARQ-ACK codebook. The single-DCI based multi-TRP may be a case in which two TCI states are activated for one or more values (code points) of the TCI field and the CORESET pool index is not configured. For the joint HARQ-ACK codebook, the UE may determine a beam, based on specific DCI corresponding to a specific HARQ-ACK information bit in the HARQ-ACK codebook.

In the single-DCI based multi-TRP, the joint HARQ-ACK codebook need not be explicitly configured, or the joint HARQ-ACK codebook (ackNackFeedbackMode=joint) may be explicitly configured.

The UE may determine one specific DCI corresponding to all of the TRPS. The specific DCI may indicate the TCI state (for example, one of the joint TCI state of the DL and the UL, the UL TCI state, and the DL TCI state) of all of the TRPs. One specific DCI may indicate the TCI state corresponding to all of the TRPs.

The DCI/PDSCH corresponding to the HARQ-ACK information bit in the HARQ-ACK codebook may be indexed in accordance with the specific parameter(s), and the specific DCI may be the last DCI in the index order (the DCI corresponding to the last index). The specific DCI may be the DCI (to be referred to) corresponding to the PRI field/CCE index used for PUCCH resource determination.

The specific CORESET pool index may be 0, or may be 1.

According to the present embodiment, even when a plurality of DCIs for the multi-TRP are transmitted, the UE can appropriately determine the TCI state.

### Other Embodiments

### UE Capability Information/Higher Layer Parameter

A higher layer parameter (RRC IE)/UE capability corresponding to a function (feature) in each embodiment described above may be defined. The higher layer parameter may indicate whether or not the function is to be enabled. The UE capability may indicate whether or not the UE supports the function.

The UE configured with the higher layer parameter corresponding to the function may perform the function. “The UE not configured with the higher layer parameter corresponding to the function does not perform the function (for example, in conformity to Rel. 15/16)” may be defined.

The UE that reports/transmits the UE capability indicating Support of the function may perform the function. “The UE not reporting the UE capability indicating support of the function does not perform the function (for example, in conformity to Rel. 15/16)” may be defined.

When the UE reports/transmits the UE capability indicating support of the function and is configured with the higher layer parameter corresponding to the function, the UE may perform the function. “When the UE does not report/transmit the UE capability indicating support of the function or is not configured with the higher layer parameter corresponding to the function, the UE does not perform the function (for example, in conformity to Rel. 15/16)” may be defined.

Which of the embodiments/options/choices/functions in the plurality of embodiments described above is used may be configured by a higher layer parameter, may be reported by the UE as a UE capability, may be defined in a specification, or may be determined by a configuration of a reported UE capability and a higher layer parameter.

The UE capability may indicate whether or not at least one of the following functions is supported.
A unified TCI framework.
One of both of the joint TCI and the separate TCI.
Dynamic unified TCI state indication using DCI. The DCI may include DCI format 1_1/1_2 with DL assignment, or may include DCI format 1_1/1_2 without DL assignment.

The UE capability may indicate at least one of the following values.
The number (maximum number) of TCI states configured for each BWP/each CC/each band/each UE.
The number (maximum number) of active TCI states for each BWP/each CC/each band/each UE.
Y [symbols] for BAT.

According to the UE capability/higher layer parameter described above, the UE can implement the above function while maintaining compatibility with existing specifications.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

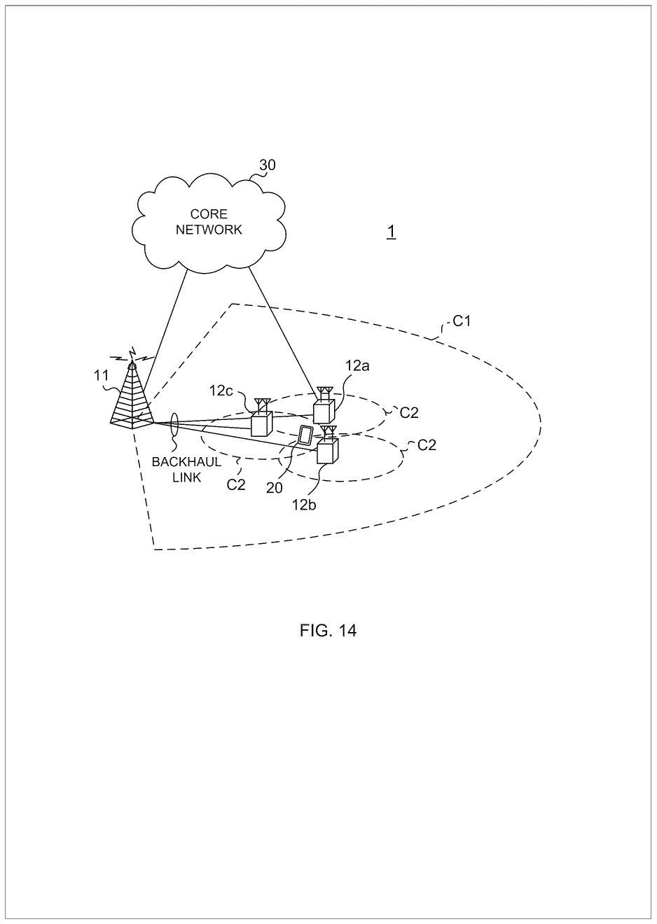

FIG. 14 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR 2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHZ (above-24 GHz) Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication) . For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are transmitted on the PDSCH. User data, higher layer control information and so on may be transmitted on the PUSCH. The Master Information Blocks (MIBs) may be transmitted on the PBCH.

Lower layer control information may be transmitted on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be transmitted by means of the PUCCH. By means of the PRACH, random access preambles for establishing connections with cells may be transmitted.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be transmitted. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be transmitted as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block, ” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be transmitted as an uplink reference signal (UL-RS). Note that DMRS may be referred to as a “user terminal specific reference signal (UE-specific Reference Signal).”

### Base Station

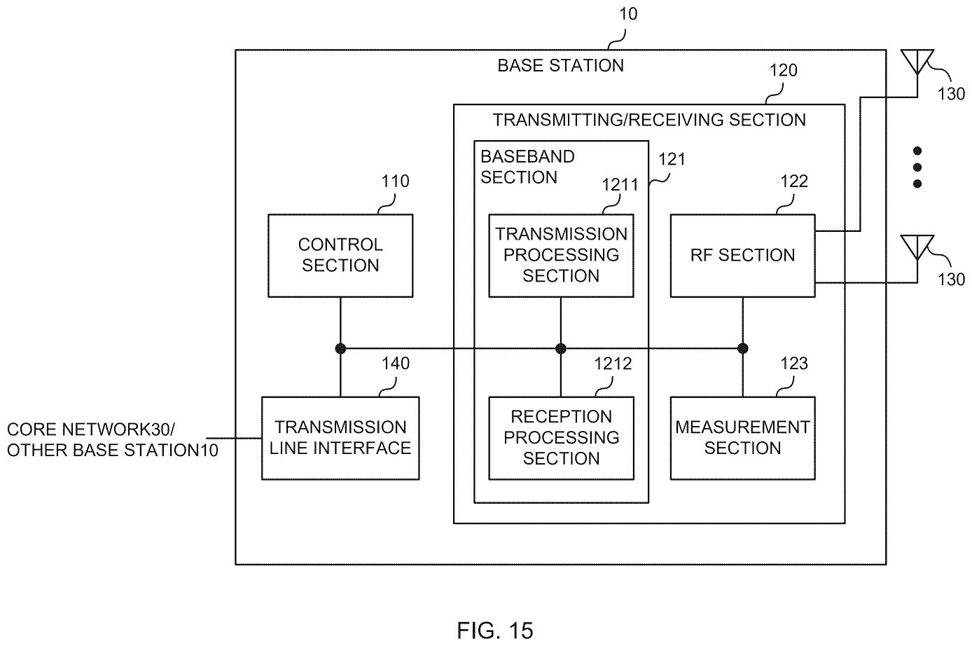

FIG. 15 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a

Transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal.

For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

The transmitting/receiving section 120 may transmit a plurality of downlink control information (DCI) formats. The control section 110 may apply one or more transmission configuration indication (TCI) states based on one or more DCI formats among the plurality of DCI formats at a specific timing after the plurality DCI formats. One of the plurality of DCI formats, a plurality of physical downlink shared channels scheduled by the plurality of DCI formats, a plurality of Hybrid Automatic Repeat reQuest ACKnowledgement (HARQ-ACK) information bits corresponding to the plurality of DCI formats, and an ACK corresponding to the plurality of DCI formats may be indexed, and the control section 110 may determine the one or more DCI formats, based on order of the index.

### User Terminal

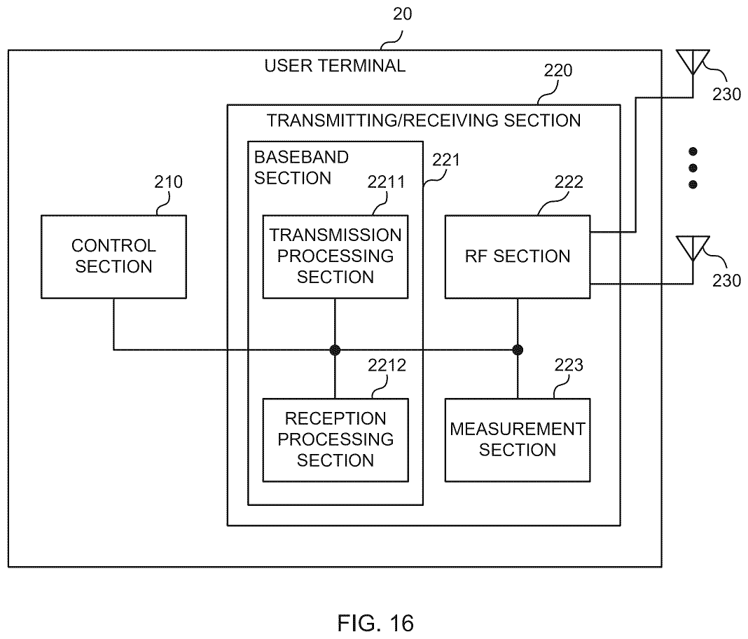

FIG. 16 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a

Transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal.

For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive a plurality of downlink control information (DCI) formats. The control section 210 may apply one or more transmission configuration indication (TCI) states based on one or more DCI formats among the plurality of DCI formats at a specific timing after the plurality of DCI formats. One of the plurality of DCI formats, a plurality of physical downlink shared channels scheduled by the plurality of DCI formats, a plurality of Hybrid Automatic Repeat reQuest ACKnowledgement (HARQ-ACK) information bits corresponding to the plurality of DCI formats, and an ACK corresponding to the plurality of DCI formats may be indexed, and the control section 210 may determine the one or more DCI formats, based on order of the index.

The plurality of HARQ-ACK information bits may be included in an HARQ-ACK codebook based on the plurality of DCI formats.

A control resource set pool index may be configured for a control resource set for the plurality of DCI formats.

Two TCI states may be associated with at least one value of a TCI field in the one or more DCI formats.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

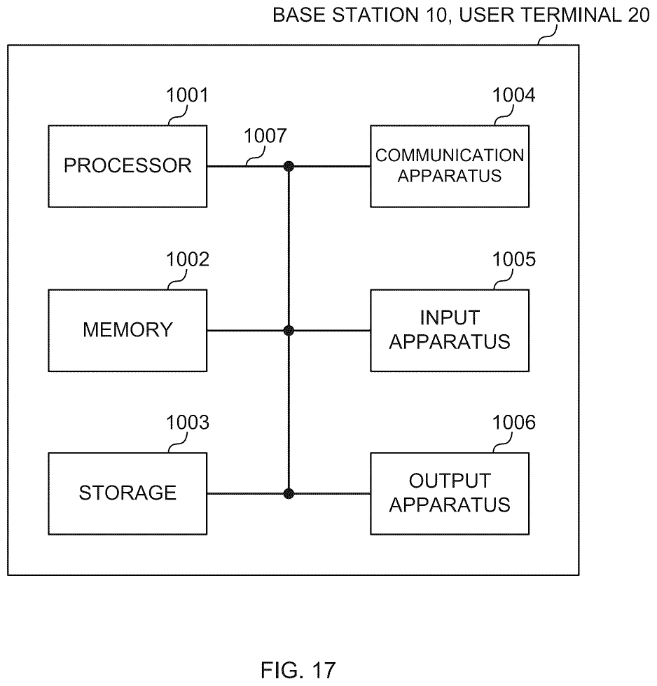

For example, a base station, a user terminal, and so on according to one embodiment of the present disclosure may function as a computer that executes the processes of the radio communication method of the present disclosure. FIG. 17 is a diagram to show an example of a hardware structure of the base station and the user terminal according to one embodiment.

Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used.

For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies.

Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot. ” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.” A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1to 13 symbols), or may be a longer period than 1 ms. Note that a unit expressing TTI may be referred to as a “slot,” a “mini-slot, ” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more ITIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be indicated by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CES).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS), ” “user terminal,” “user equipment (UE), ” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, an artificial satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an autonomous car, and the like), or may be a robot (a manned type or unmanned type). Note that at least one of a base station and a mobile station also includes an apparatus which does not necessarily move during communication operation. For example, at least one of a base station and a mobile station may be an Internet of Things (IOT) device such as a sensor.

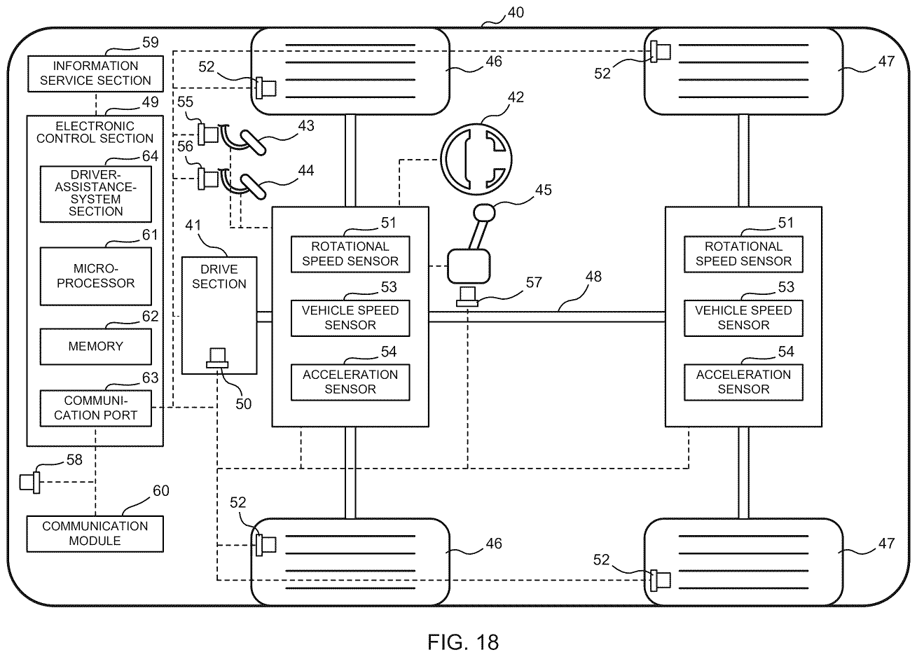

FIG. 18 is a diagram to show an example of a vehicle according to one embodiment. A vehicle 40 includes a drive section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The drive section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driver-assistance-system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUS that control these devices. The driver-assistance-system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and From the Drive Section 41, the Steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle.

The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the drive section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “sidelink”). For example, an uplink channel, a downlink channel, and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining) ” as in the present disclosure herein may encompass a wide variety of actions. For example, “judging (determining) ” may be interpreted to mean making “judgments (determinations) ” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1-8. (canceled)

9. A terminal comprising:
a receiver that receives a plurality of downlink control information (DCI) formats; and
a processor that applies a transmission configuration indication (TCI) state based on a specific DCI format among the plurality of DCI formats at a specific timing after the plurality of DCI formats,
wherein indices are assigned to the plurality of DCI formats, a plurality of physical downlink shared channels scheduled by the plurality of DCI formats, a plurality of hybrid automatic repeat request acknowledgement (HARQ-ACK) information bits corresponding to the plurality of DCI formats, or ACKs corresponding to the plurality of DCI formats, and
the processor determines the specific DCI format based on order of the indices.

10. The terminal according to claim 9, wherein the plurality of HARQ-ACK information bits are included in a HARQ-ACK codebook based on the plurality of DCI formats.

11. The terminal according to claim 9, wherein control resource set pool indices are configured for control resource sets for the plurality of DCI formats, respectively.

12. The terminal according to claim 10, wherein control resource set pool indices are configured for control resource sets for the plurality of DCI formats, respectively.

13. The terminal according to claim 9, wherein two TCI states are associated with at least one value of a TCI field in the specific DCI format.

14. The terminal according to claim 10, wherein two TCI states are associated with at least one value of a TCI field in the specific DCI format.

15. The terminal according to claim 9, wherein a DCI format in which a TCI field is not present, among the plurality of DCI formats, is not the specific DCI format.

16. The terminal according to claim 9, wherein the specific DCI format is a last DCI of DCIs corresponding to ACK in the plurality of HARQ-ACK information bits included in a HARQ-ACK codebook.

17. A radio communication method for a terminal, comprising:
receiving a plurality of downlink control information (DCI) formats; and
applying a transmission configuration indication (TCI) state based on a specific DCI format among the plurality of DCI formats at a specific timing after the plurality of DCI formats,
wherein indices are assigned to the plurality of DCI formats, a plurality of physical downlink shared channels scheduled by the plurality of DCI formats, a plurality of hybrid automatic repeat request acknowledgement (HARQ-ACK) information bits corresponding to the plurality of DCI formats, or ACKs corresponding to the plurality of DCI formats, and
the terminal determines the specific DCI format based on order of the indices.

18. A base station comprising:
a transmitter that transmits a plurality of downlink control information (DCI) formats; and
a processor that applies a transmission configuration indication (TCI) state based on a specific DCI format among the plurality of DCI formats at a specific timing after the plurality of DCI formats,
wherein indices are assigned to the plurality of DCI formats, a plurality of physical downlink shared channels scheduled by the plurality of DCI formats, a plurality of hybrid automatic repeat request acknowledgement (HARQ-ACK) information bits corresponding to the plurality of DCI formats, or ACKs corresponding to the plurality of DCI formats, and
the processor determines the specific DCI format based on order of the indices.

19. A system comprising a terminal and a base station, wherein
the terminal comprises:
a receiver that receives a plurality of downlink control information (DCI) formats; and
a processor that applies a transmission configuration indication (TCI) state based on a specific DCI format among the plurality of DCI formats at a specific timing after the plurality of DCI formats,
wherein indices are assigned to the plurality of DCI formats, a plurality of physical downlink shared channels scheduled by the plurality of DCI formats, a plurality of hybrid automatic repeat request acknowledgement (HARQ-ACK) information bits corresponding to the plurality of DCI formats, or ACKs corresponding to the plurality of DCI formats, and
the processor determines the specific DCI format based on order of the indices, and
the base station comprises:
a transmitter that transmits the plurality of DCI formats; and
a processor that applies the TCI state based on the specific DCI format among the plurality of DCI formats at the specific timing after the plurality of DCI formats.
